(19) United States
(12) Patent Application Publication
(10) Pub. No.: US 2025/0206124 A1
(43) Pub. Date: Jun. 26, 2025

(54) ELECTRIC MOTOR VEHICLE

(71) Applicant: TOYOTA JIDOSHA KABUSHIKI KAISHA, Toyota-shi Aichi-ken (JP)

(72) Inventor: Nakaya TAKAGAKI, Toyota-shi Aichi-ken (JP)

(73) Assignee: TOYOTA JIDOSHA KABUSHIKI KAISHA, Toyota-shi Aichi-ken (JP)

(21) Appl. No.: 18/986,963

(22) Filed: Dec. 19, 2024

(30) Foreign Application Priority Data
Dec. 22, 2023 (JP) 2023-216570

(51) Int. Cl. B60K 1/04; B60K 11/04; B62D 21/03; H01M 50/249

(52) U.S. Cl. CPC B60K 1/04; B60K 11/04; B62D 21/03; H01M 50/249; B60K 2001/0438; H01M 2220/20

(57) ABSTRACT

An electric motor vehicle includes left and right side rails extending along a length of the vehicle, a battery disposed between the left and right side rails, an electric motor unit disposed in a further rearward part in the vehicle with respect to the battery, an auxiliary machine unit disposed in a further forward part in the vehicle with respect to the battery, and a connecting member connecting the auxiliary machine unit and the electric motor unit along the length of the vehicle. The connecting member is upwardly spaced from the battery.

### CROSS REFERENCE TO RELATED APPLICATION

This application claims priority to Japanese Patent Application No. 2023-216570 filed on Dec. 22, 2023, which is incorporated herein by reference in its entirety including the specification, claims, drawings, and abstract.

### TECHNICAL FIELD

The present disclosure relates to a structure of an electric motor vehicle.

### BACKGROUND

CN 115284949 A discloses, in the specification, a battery electric vehicle (hereinafter referred to as a “BEV”) including a battery that is secured, in a hanging manner, to the underside of a frame composed of left and right side rails and a plurality of cross members extending across the space between the left and right side rails.

US 2020/0331334 discloses, in the specification, an electric motor truck including a frame composed of left and right side rails and a plurality of cross members extending across the space between the left and right sider rails. This electric motor truck also includes a battery that is secured underneath the frame in a hanging manner. This electric motor truck further includes a front compartment accommodating electric accessories in a front part of the truck, and includes a drive unit mounted in a further rearward part with respect to the battery.

### SUMMARY

In frame-based electric motor vehicles, to secure a sufficient space for installing the battery, a configuration including the battery between the side rails, while disposing an auxiliary machine unit in a further forward part with respect to the battery and disposing the electric motor unit in a further rearward part with respect to the battery, has been considered. This configuration requires that the auxiliary machine unit in the front part and the electric motor unit in the rear part should be connected along the vehicle length through a connecting member. The connecting member connects the auxiliary machine unit and the electric motor unit across the battery along the vehicle length direction.

Meanwhile, the battery may expand and deform due to thermal diffusion. At this time, the top surface of the battery is subjected to a temperature rise and curves and bends upward into a protrusion, which may cause the battery to interfere with the connecting member and damage the connecting member.

The present disclosure is therefore aimed toward reducing interference between a battery and a connecting member in a frame-based electric motor vehicle.

In accordance with an aspect of the disclosure, an electric motor vehicle includes left and right side rails extending along a length of the vehicle; a battery disposed between the left and right side rails; an electric motor unit disposed in a further rearward part in the vehicle with respect to the battery; an auxiliary machine unit disposed in a further forward part in the vehicle with respect to the battery; and a connecting member connecting the auxiliary machine unit and the electric motor unit along the length of the vehicle. The connecting member is upwardly spaced from the battery.

The configuration including the connecting member upwardly spaced from the battery as described above enables reduction of interference of the battery with the connecting member when it is expanded and deformed.

The electric motor vehicle according to the disclosure may further include at least one cross bracket extending between the left and right side rails above the battery, and the connecting member may be disposed above a center portion of the cross bracket in the width direction of the vehicle.

The configuration including the connecting member disposed above the center portion of the cross bracket as described above prevents contact of a battery, that has an expansion and a deformation due to raised temperature, with the connecting member, and also prevents damage to the connecting member caused by deformation of the side rail in a side collision. This configuration further enables a reduction in the route of the connecting member compared to a connecting member disposed along the side rails.

In the electric motor vehicle according to the disclosure, the at least one cross bracket may include a plurality of cross brackets, and the plurality of cross brackets may be arranged at predetermined intervals along the length of the vehicle.

This configuration prevents the connecting member that extends along the vehicle length from sagging downward and contacting the battery.

In the electric motor vehicle according to the disclosure, the cross bracket may include, at a lower end, a planar portion extending along a top surface of the battery.

This configuration allows a battery, that is expanded and deformed and interferes with the cross bracket, to contact the planar face, and thus prevents damage to the battery.

In the electric motor vehicle according to the disclosure, the cross bracket may have left and right end portions each having an L-shape cross section, with the center portion having a C-shape cross section opened forward or rearward of the vehicle.

This simple configuration prevents damage to a battery that is expanded and deforms and interferes with the cross bracket. This configuration further reduces rigidity of the cross bracket, thereby enabling a reduction in effects on the deformation mode of the side rails in a collision.

In the electric motor vehicle according to the disclosure, each of the left and right end portions of the cross bracket may have an L-shape cross section composed of an upper plate and a vertical plate extending downward from the upper plate. The electric motor vehicle may further include left and right attachment brackets configured to be attached to the left and right side rails, respectively, and extend upward, and the left and right attachment brackets may each have, at an upper part, a plate flange configured to be fastened to the vertical plate of each of the left and right end portions. The cross bracket may include an arm portion at one or both the left and right end portions, and the arm portion may extend downward from the upper plate to hold the plate flange of the attachment bracket between the arm portion and the vertical plate.

This configuration allows the plate flange of one of the left and right attachment brackets, which will be referred to as one plate flange, to be held between the vertical plate and the arm portion of the cross bracket, to thereby allow one end portion of the cross bracket to be temporarily held by the one attachment bracket. Then, with the one end portion of the cross bracket being temporarily held, the vertical plate of the other end portion is fastened to the other plate flange, and thereafter, the vertical plate of the one end portion is fasted to the one plate flange. This configuration enables mounting operation of the cross bracket by a single person.

In the electric motor vehicle according to the disclosure, the auxiliary machine unit may include a radiator, and the connecting member may be a cooling conduit line extending along the length of the vehicle between the radiator and the electric motor unit to cause cooling water to circulate between the radiator and the electric motor unit.

This configuration enables prevention of interference of a battery, that is expanded and deformed, with the cooling conduit line.

In the electric motor vehicle according to the disclosure, the auxiliary machine unit may include a power distributor configured to distribute electric power from the battery, to the electric motor unit and another on-vehicle device, and the connecting member may be a power cable configured to transmit electric power from the power distributor to the electric motor unit.

This configuration enables prevention of interference of a battery, that is expanded and deformed, with the power cable.

In the electric motor vehicle according to the disclosure, the auxiliary machine unit may include a radiator and a power distributor configured to distribute electric power from the battery, to the electric motor unit and another on-vehicle device, and the connecting member may be a cooling conduit line extending between the radiator and the electric motor unit along the length of the vehicle to cause cooling water to circulate between the radiator and the electric motor unit, and a power cable configured to transmit electric power from the power distributor to the electric motor unit.

This configuration enables prevention of interference of a battery, that is expanded and deformed, with one or both of the cooling conduit line and the power cable.

The electric motor vehicle according to the disclosure may further include a cab mounted above the left and right side rails in a front part of the vehicle and a deck mounted in a further rearward part in the vehicle with respect to the cab above the left and right side rails. The cross bracket may be disposed within a region between the left and right side rails where the deck is mounted, and the connecting member may include a forward portion supported by a floor panel of the cab and a rearward portion disposed above the center portion of the cross bracket in a vehicle width direction, to maintain a substantially identical height with the forward portion.

This simple configuration enables the forward portion of the connecting member and rearward portion of the connecting member to be disposed at substantially the same height level in a frame-based electric motor vehicle including a cab and a deck.

The present disclosure enables prevention of interference between a battery and a connecting member in a frame-based electric motor vehicle.

### BRIEF DESCRIPTION OF DRAWINGS

Embodiments of the present disclosure will be described based on the following figures, wherein:

FIG. 1 is a plan view illustrating an electric motor vehicle according to an embodiment;

FIG. 2 is a cross section and side elevation view of the electric motor vehicle illustrated in FIG. 1, and illustrates an A-A cross section in FIG. 1;

FIG. 3 is a cross section and elevation view of the electric motor vehicle illustrated in FIG. 1, and illustrates a B-B cross section in FIG. 1;

FIG. 4 is an exploded perspective view of a frame and a cross bracket of the electric motor vehicle illustrated in FIG. 1 as viewed from in front of and to the right side of the vehicle;

FIG. 5 is a cross sectional view illustrating sectional shapes of an end portion and a center portion of the cross bracket;

FIG. 6 is a perspective view of a left end portion of the cross bracket and a left attachment bracket as viewed from behind and to the right side of the vehicle;

FIG. 7 is a perspective view of a right end portion of the cross bracket and a right attachment bracket as viewed from in front of and to the right side of the vehicle;

FIG. 8 is a plan view of an electric motor vehicle according to a further embodiment;

FIG. 9 is a plan view of an electric motor vehicle according to a still further embodiment;

FIG. 10 is a cross section and elevation view of an electric motor vehicle according to a further embodiment; and

FIG. 11 is a cross section and side elevation view of an electric motor vehicle according to a further embodiment.

### DESCRIPTION OF EMBODIMENTS

An electric motor vehicle 100 according to an embodiment will be described below by reference to the drawings. In each drawing, symbols FR, UP, and RH denote frontward, upward, and rightward directions, respectively, of the electric motor vehicle 100. Directions opposite to FR, UP, and RH indicate rearward, downward, and leftward, respectively. In the following description, simple description of the front-rear or longitudinal or length direction, the left-right or transverse or width direction, and the up-down or vertical or height direction refer to the front and rear in the longitudinal or length direction, left and right in the transverse or width direction, and above and below in the vertical or height direction, respectively, of the electric motor vehicle 100, unless otherwise specified.

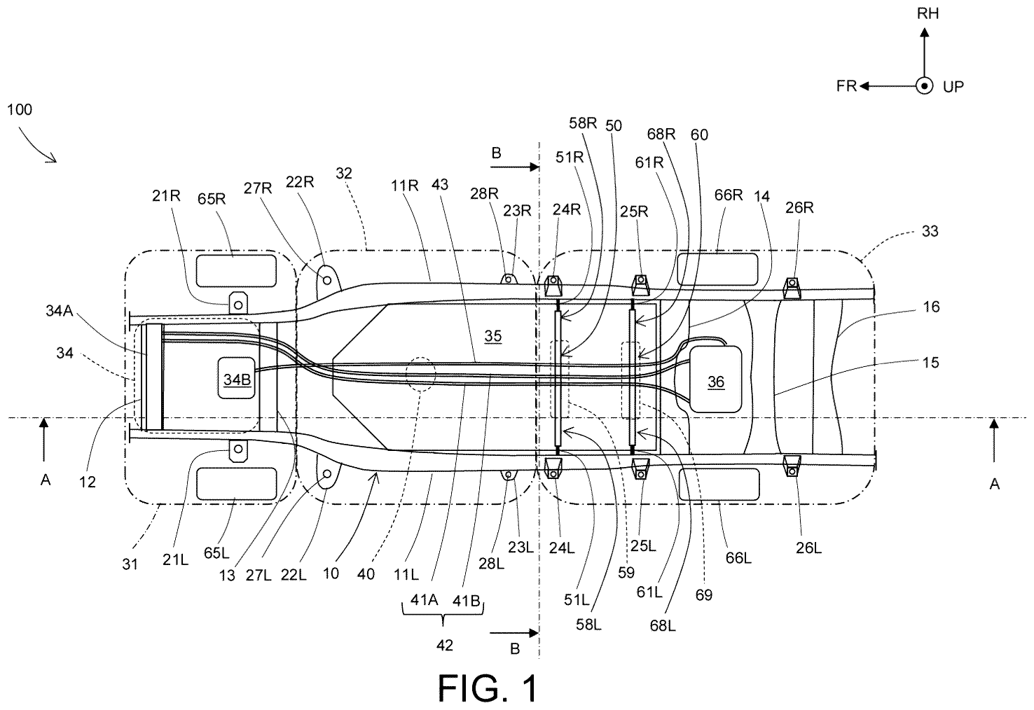

As illustrated in FIG. 1, the electric motor vehicle 100 includes a frame 10, a battery 35, an electric motor unit 36, an auxiliary machine unit 34, a front compartment 31, a cab 32, a deck 33, and first and second cross brackets 50 and 60. The electric motor vehicle 100 is a battery electric vehicle that drives the electric motor unit 36 for travelling, with electric power supplied from the battery 35 that is charged by an external power source.

As illustrated in FIG. 1, the frame 10 is a ladder-shape frame member composed of left and right side rails 11L and 11R, and first to fifth cross members 12, 13, 14, 15, and 16 extending across the vehicle width or transverse direction between the left and right side rails 11L and 11R. Front suspension brackets 21L and 21R are attached outside, in the vehicle width direction, of the left and right side rails 11L and 11R, respectively, between the first cross member 12 and the second cross member 13 in a front part of the vehicle. Suspension systems of left and right front wheels 65L and 65R, respectively, are attached to the front suspension brackets 21L and 21R, respectively. The front compartment 31 is disposed above a space between the first cross member 12 and the second cross member 13. Similarly, suspension systems (not shown) of left and right rear wheels 66L and 66R respectively, are mounted between the third cross member 14 and the fourth cross member 15 in a rear part of the vehicle.

Front cab mount brackets 22L and 22R are disposed outside the left and right side rails 11L and 11R, respectively, along the vehicle width in a further rearward part of the vehicle relative to the second cross member 13. Front cab mounts 27L and 27R are further disposed on the front cab mount brackets 22L and 22R, respectively, to support the left and right sides in the forward portion of the cab 32. Further, rear cab mount brackets 23L and 23R are disposed outside the left and right side rails 11L and 11R, respectively, between the second cross member 13 and the third cross member 14. Rear cab mounts 28L and 28R are further disposed on the rear cab mount brackets 23L and 23R, respectively, to support the left and right sides in the rearward portion of the cab 32. Left and right first deck mounts 24L and 24R, left and right second deck mounts 25L and 25R, and left and right third deck mounts 26L and 26R are further disposed on the left and right side rails 11L and 11R, respectively, in further rearward areas relative to the respective rear cab mount brackets 23L and 23R. The left and right first to third deck mounts 24L, 24R, 25L, 25R, 26L, and 26R support the deck 33.

The battery 35 is mounted between the left and right side rails 11L and 11R in a region between the second cross member 13 and the third cross member 14. The electric motor unit 36 that drives the left and right rear wheels 66R and 66L is mounted between the third cross member 14 and the fourth cross member 15. The front compartment 31 in the front part of the vehicle accommodates the auxiliary machine unit 34. Thus, the electric motor unit 36 is disposed in a further rearward part in the vehicle with respect to the battery 35, and the auxiliary machine unit 34 is disposed in a further forward part in the vehicle with respect to the battery 35.

The battery 35 is a high-voltage device that is charged by an external power source and supplies driving electric power to the electric motor unit 36. The electric motor unit 36 is an integral device composed of a travelling motor, a gear, an inverter, and an oil pump, for example. The auxiliary machine unit 34 includes a radiator 34A and a power distributor 34B. The radiator 34A is a heat exchanger that externally discharges heat of the cooling water for cooling the electric motor unit 36. The power distributor 34B distributes the electric power input from the battery 35 into high-voltage driving power to be supplied to the electric motor unit 36 and low-voltage auxiliary machine power to be supplied to another on-vehicle device. The auxiliary machine unit 34 may additionally include an air-conditioning compressor, a condenser, an electric coolant heater, and an auxiliary machine battery, for example.

The radiator 34A and the electric motor unit 36 are connected with each other through a cooling conduit line 42 composed of a cooling water supply line 41A and a cooling water return line 41B. Further, the power distributor 34B and the electric motor unit 36 are connected with each other through a power cable 43. The cooling conduit line 42 and the power cable 43 constitute a connecting member 40 that connects the auxiliary machine unit 34 and the electric motor unit 36 along the vehicle length direction. As will be described below, the cooling conduit line 42 and the power cable 43 are upwardly spaced from the battery 35.

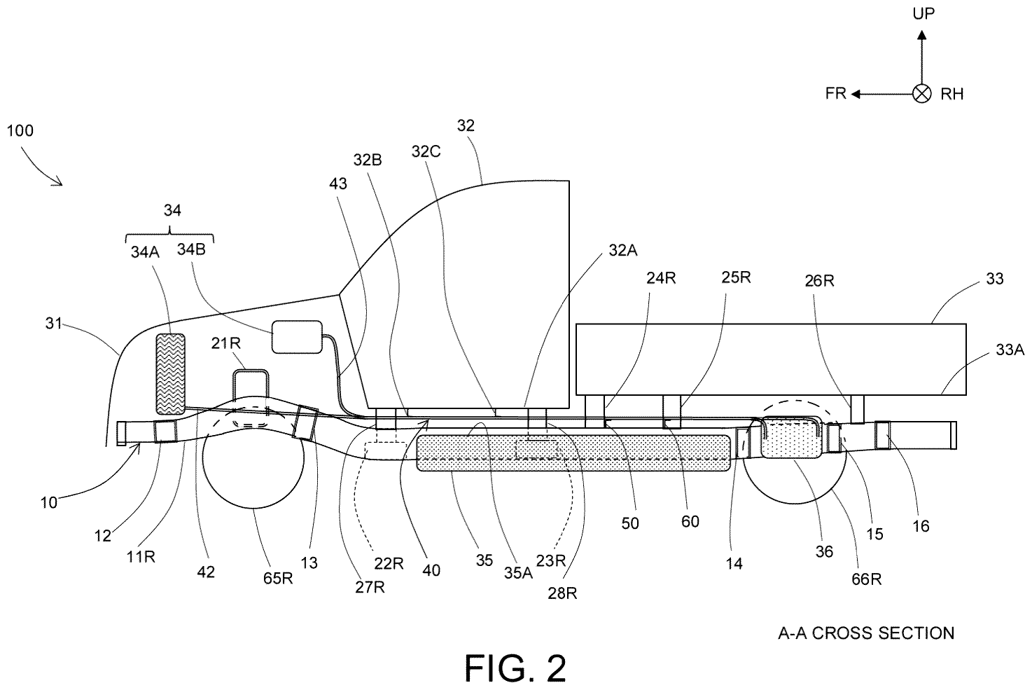

As illustrated in FIG. 2, the cab 32 is mounted on the left and right front cab mounts 27L and 27R and the left and right rear cab mounts 28L and 28R. The interior of the cab 32 serves as a vehicle cabin that an occupant of the electric motor vehicle 100 gets into. The deck 33 is mounted on the left and right first to third deck mounts 24L, 24R, 25L, 25R, 26L, and 26R in a further rearward area relative to the cab 32. The deck 33 provides a space accommodating baggage. A floor panel 33A of the deck 33 is located at a higher level than a floor panel 32A of the cab 32.

As illustrated in FIG. 1, the first and second cross brackets 50 and 60 are disposed in a further frontward part in the vehicle with respect to the third cross member 14 within a region where the deck 33 is mounted, and extend between the left and right side rails 11L and 11R. The first and second cross brackets 50 and 60 are arranged at an interval along the vehicle length. The first cross bracket 50 is composed of a center portion 59 in the center along the vehicle width, and left and right end portions 58L and 58R located further outward in the vehicle width direction with respect to the center portion 59. Similarly, the second cross bracket 60 is composed of a center portion 69 in the center along the vehicle width, and left and right end portions 68L and 68R, located further outward in the vehicle width direction with respect to the center portion 69.

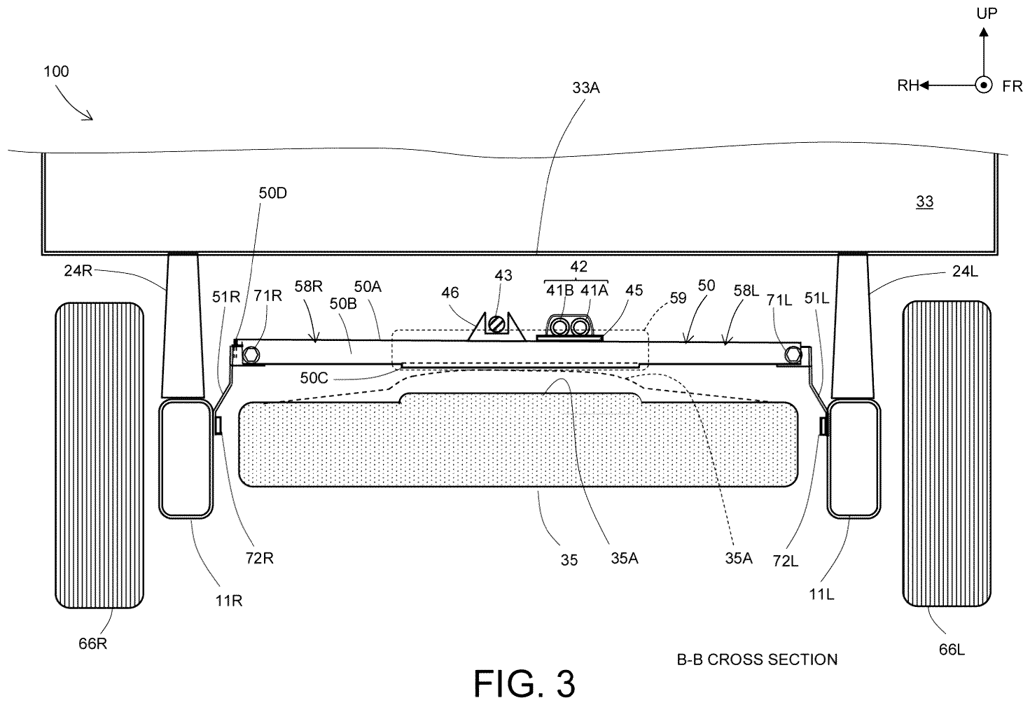

The first cross bracket 50 is attached to the left and right side rails 11L and 11R via left and right attachment brackets 51L and 51R, respectively. As illustrated in FIG. 3, the left and right attachment brackets 51L and 51R are folded plate members secured to inner faces of the left and right side rails 11L and 11R in the transverse direction, respectively, via respective bolts 72L and 72R, and extending upward. The upper parts of the left and right attachment brackets 51L and 51R extend further upward relative to a top surface 35A of the battery 35. The first cross bracket 50 is secured to the upper parts of the left and right attachment brackets 51L and 51R with bolts 71L and 71R, respectively, such that the undersurface of the first cross bracket 50 is located above the top surface 35A of the battery 35. As described above, the first cross bracket 50 extends across a space between the left and right side rails 11L and 11R above the battery 35.

The second cross bracket 60 has the same configuration as the first cross bracket 50. Left and right attachment brackets 61L and 61R also have the same configuration as the left and right attachment brackets 51L and 51R. The second cross bracket 60, similar to the first cross bracket 50, extends across a space between the left and right side rails 11L and 11R above the battery 35. The detailed structures of the first and second cross brackets 50 and 60, and of the attachment brackets 51L, 51R, 61L, and 61R will be described below.

Referring to FIG. 1 to FIG. 3, the arrangement and route of the cooling conduit line 42 and the power cable 43 will be described.

As illustrated in FIGS. 1 and 2, the cooling conduit line 42 extends rearward of the vehicle from a lower right portion of the radiator 34A, curves at the back of the second cross member 13 toward the center in the transverse direction, then extends rearward along the center in the transverse direction, and is connected to the electric motor unit 36. As illustrated in FIG. 2, the cooling conduit line 42 is disposed under the front compartment 31, the cab 32, and the deck 33, and above the battery 35. The cooling conduit line 42 is suspended from the floor panel 32A of the cab 32 with hanging members 32B and 32C under the cab 32. The cooling conduit line 42 is also disposed above the first and second cross brackets 50 and 60 under the deck 33. More specifically, the cooling conduit line 42 is disposed on a mount 45 attached to the center portion 59 of the first cross bracket 50, as illustrated in FIG. 3. Further, as illustrated in FIG. 2, under the cab 32 and the deck 33, the cooling conduit line 42 is disposed to maintain a substantially even height level.

As illustrated in FIG. 1, the power cable 43 extends from the power distributor 34B in the front part of the vehicle toward the electric motor unit 36 in the rear part of the vehicle along the center in the transverse direction. As illustrated in FIG. 2, the power cable 43 extends rearward from the power distributor 34B, subsequently, bends and extends downward within the front compartment 31, and then bends and extends rearward of the vehicle. The power cable 43 is, similar to the cooling conduit line 42, disposed under the cab 32 and the deck 33 and above the battery 35. Under the cab 32, the power cable 43 is suspended from the floor panel 32A of the cab 32 with hanging members 32B and 32C. The power cable 43 is also disposed above the first and second cross brackets 50 and 60 under the deck 33. More specifically, the power cable 43 is disposed on a support 46 attached in the center portion 59 of the first cross bracket 50, as illustrated in FIG. 3. The power cable 43 is, similar to the cooling conduit line 42, disposed to maintain substantially the even height level, under the cab 32 and the deck 33.

As described above, the cooling conduit line 42 and the power cable 43 are disposed above the center portions 59 and 69 of the first and second cross brackets 50 and 60, at an interval from the top surface 35A of the battery 35. The forward portion of the cooling conduit line 42 and the forward portion of the power cable 43 are supported by the floor panel 32A of the cab 32. The rearward portion of the cooling conduit line 42 and the rearward portion of the power cable 43 are supported on the center portions 59 and 69 of the first and second cross brackets 50 and 60, respectively, such that each rearward portion has substantially the same height level as the corresponding forward portion.

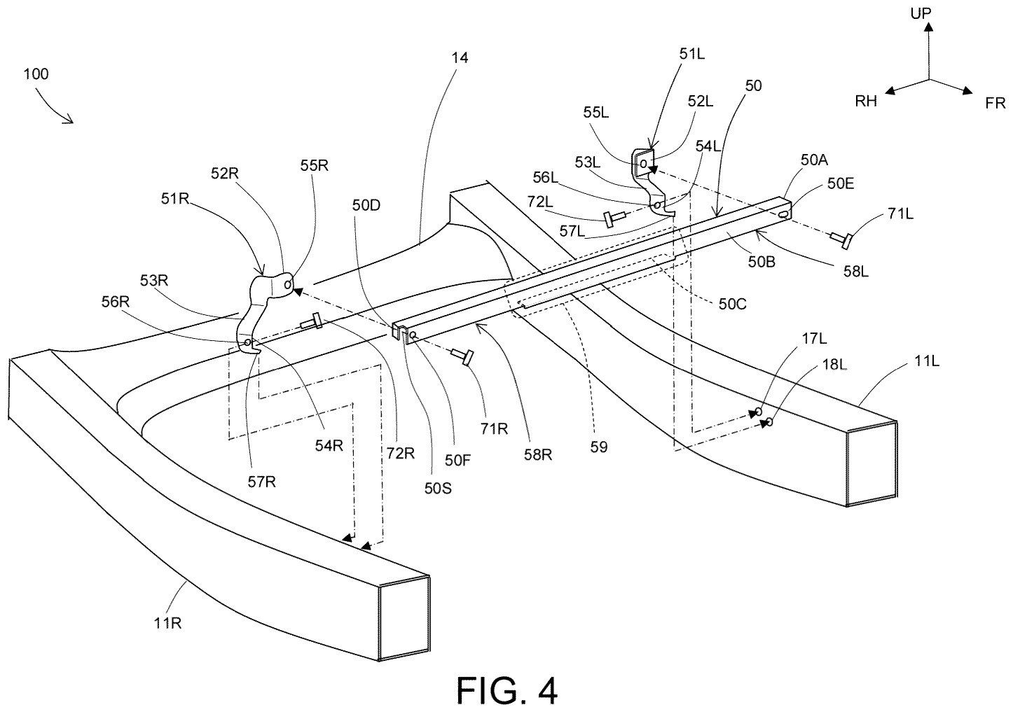

Referring now to FIG. 4 to FIG. 7, the detailed structures of the first cross bracket 50 and the left and right attachment brackets 51L and 51R will be described. The second cross bracket 60 and the left and right attachment brackets 61L and 61R, which have the same structures as the first cross bracket 50 and the left and right attachment brackets 51L and 51R, will not be further described.

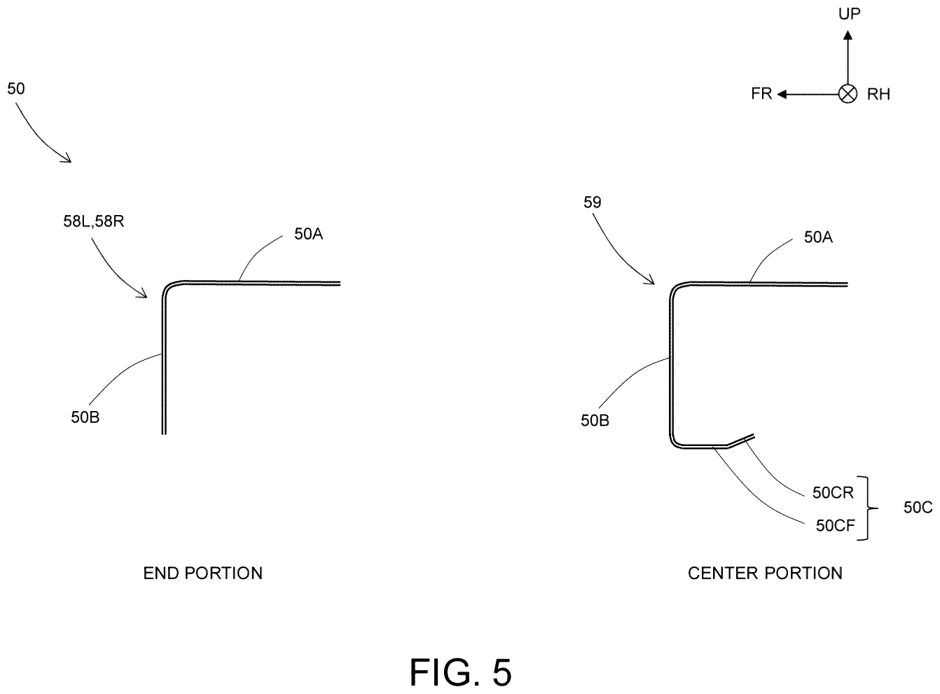

As illustrated in FIG. 5, the first cross bracket 50 has left and right end portions 58L and 58R each having an L-shape cross section composed of an upper plate 50A and a vertical plate 50B extending downward from the front edge of the upper plate 50A. The center portion 59 of the first cross bracket 50 is composed of the upper plate 50A, the vertical plate 50B, and a lower plate 50C extending rearward of the vehicle from a lower edge of the vertical plate 50B, and has a C-shape cross section that is opened rearward. As illustrated in FIG. 5, the lower plate 50C is composed of a forward portion 50CF and a rearward portion 50CR. The forward portion 50CF extends horizontally rearward of the vehicle from the lower edge of the vertical plate 50B. The rearward portion 50CR extends diagonally upward from the rear end of the forward portion 50CF. When the first cross bracket 50 is attached to the left and right side rails 11L and 11R and the battery 35 is mounted between the left and right side rails 11L and 11R, the forward portion 50CF constitutes a planar portion that is located at the lower end of the center portion 59 and extends horizontally along the top surface 35A of the battery 35.

As illustrated in FIG. 4, the first cross bracket 50 has, at the right end portion 58R, a plate-shape arm portion 50D extending downward from the right edge of the upper plate 50A, and a space 50S is provided between the arm portion 50D and the vertical plate 50B. The vertical plate 50B includes, at the left end and the right end, respective bolt holes 50E and 50F, of which the bolt hole 50E is an elongate hole and the bolt hole 50F is a circular hole.

As illustrated in FIGS. 3 and 4, the left attachment bracket 51L includes a fixing part 54L, a body part 53L, a plate flange 52L, and an inserting part 57L. The fixing part 54L is a plate-like part to be fixed to an inner face of the left side rail 11L in the vehicle width direction. The body part 53L is also a plate-like part extending upward from an upper edge of the fixing part 54L. The plate flange 52L is a plate-like part extending inward in the vehicle width direction from a forward edge in the upper portion of the body part 53L. The inserting part 57L is a part that is bent outward in the vehicle width direction from the fixing part 54L. The fixing part 54L has a bolt hole 56L, and the plate flange 52L includes a bolt hole 55L.

The right attachment bracket 51R, which is symmetrical with the left attachment bracket 51L, includes a fixing part 54R, a body part 53R, a plate flange 52R, and an inserting part 57R. The fixing part 54R and the plate flange 52R include bolt holes 56R and 55R, respectively.

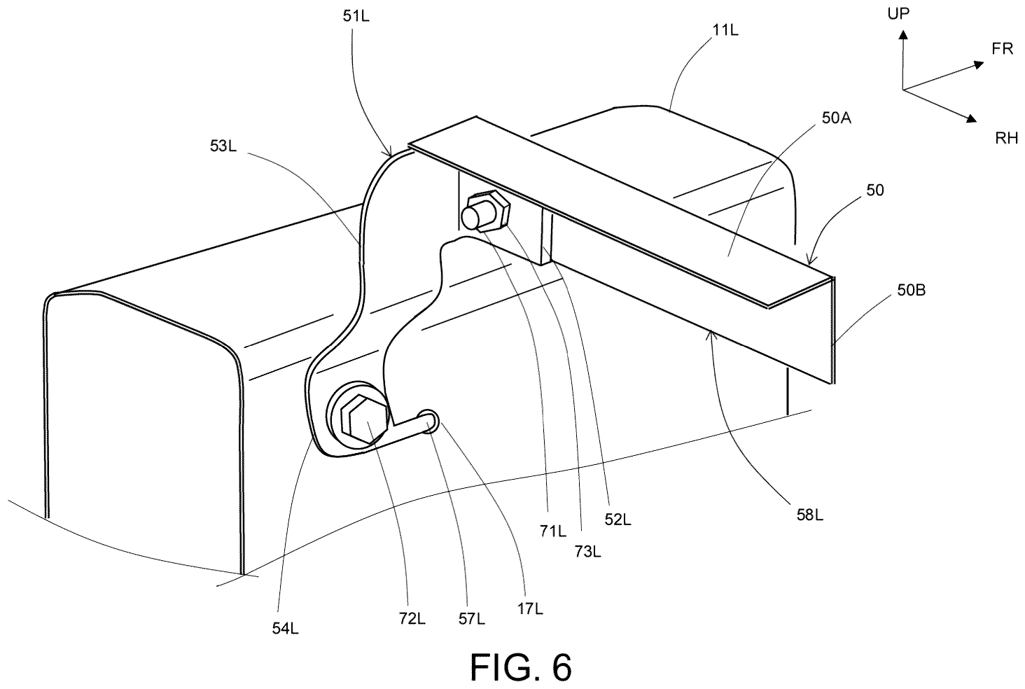

The left attachment bracket 51L is fixed to an inner face of the side rail 11L in the vehicle width direction by inserting the tip end of the inserting part 57L into a hole 18L on the side rail 11L and screwing a bolt 72L into a screw hole 17L on the side rail 11L through the bolt hole 56L of the fixing part 54L, as illustrated in FIG. 6. As illustrated in FIG. 4, the fixing part 54R of the right attachment bracket 51R is fixed to the inner face of the side rail 11R in the vehicle width direction with a bolt 72R.

As illustrated in FIGS. 4 and 6, the left end portion 58L of the first cross bracket 50 is attached to the left attachment bracket 51L by inserting a bolt 71L through the bolt hole 50E and the bolt hole 55L of the plate flange 52L and then screwing the bolt 71L into a nut 73L disposed on the opposite side of the plate flange 52L.

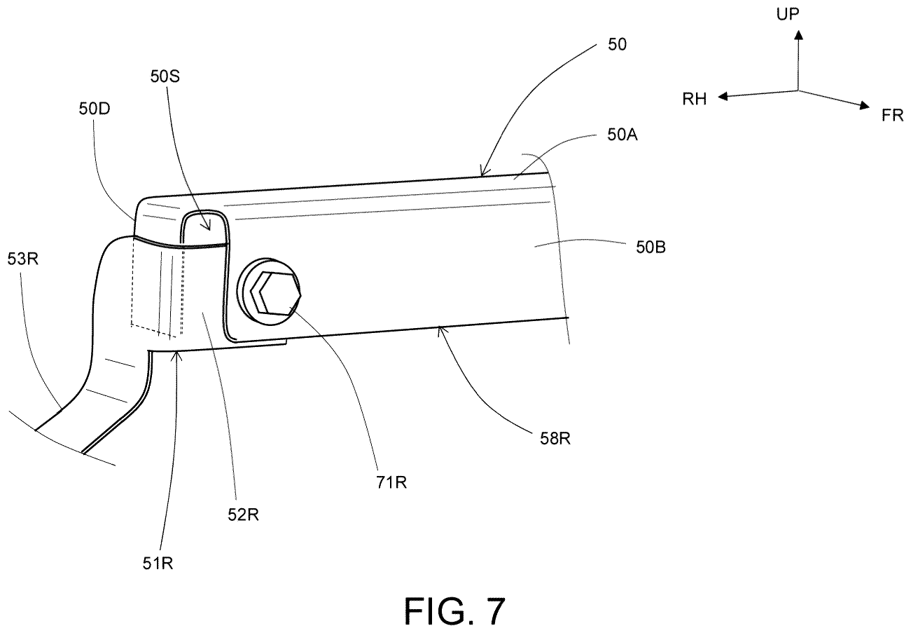

As illustrated in FIGS. 4 and 7, the right end portion 58R of the first cross bracket 50 is attached to the right attachment bracket 51R by inserting the plate flange 52R of the right attachment bracket 51R into the space 50S, inserting a bolt 71R into the bolt hole 50F and the bolt hole 55R of the plate flange 52R, and then screwing the bolt 71 into the nut (not shown) disposed on the opposite side of the plate flange 52R.

In the electric motor vehicle 100 configured as described above, the cooling conduit line 42 and the power cable 43 are upwardly spaced from the top surface 35A of the battery 35. This configuration enables prevention of interference of the top surface 35A of the battery 35 with the cooling conduit line 42 and the power cable 43 when the battery 35 is deformed by expansion caused by thermal diffusion that causes the top surface 35A of the battery 35 to curve upward as illustrated with a broken line in FIG. 3. This configuration also enables prevention of thermal damage to the cooling conduit line 42 and power cable 43 caused by a temperature rise of the battery 35 at the time of thermal diffusion.

In the electric motor vehicle 100, the cooling conduit line 42 and the power cable 43 are disposed above the respective center portions 59 and 69 of the first and second cross brackets 50 and 60. This configuration enables prevention of contact of the top surface 35A of the battery 35, that is deformed by expansion and has a raised temperature, with the cooling conduit line 42 and the power cable 43. This configuration also enables prevention of damage to the cooling conduit line 42 and power cable 43 caused by the left and right side rails 11L and 11R that are deformed inward in the vehicle width direction at the time of a side collision. The cooling conduit line 42 and the power cable 43 are disposed to extend linearly along the vehicle length in the center in the vehicle width direction and to connect to the electric motor unit 36 disposed in the center in the vehicle width direction. This configuration shortens the routes of the cooling conduit line 42 and the power cable 43 compared to a configuration including the cooling conduit line 42 and the power cable 43 disposed along the left and right side rails 11L and 11R.

Further, the electric motor vehicle 100 includes the first and second cross brackets 50 and 60 at predetermined intervals along the vehicle length. This configuration enables prevention of the cooling conduit line 42 and the power cable 43 from sagging downward toward the top surface 35A of the battery 35. This configuration thus prevents contact of the top surface 35A of the battery 35, that is expanded due to thermal diffusion, with the cooling conduit line 42 and the power cable 43. This configuration further prevents thermal damage to the cooling conduit line 42 and the power cable 43 caused by the battery 35 having a raised temperature due to thermal diffusion.

In addition, in the electric motor vehicle 100, the center portion 59, 69 of each of the first and second cross brackets 50 and 60 has a C-shape cross section opened rearward, with the forward portion 50CF of the lower plate 50C forming a planar face extending horizontally along the top surface 35A of the battery 35. This configuration allows the top surface 35A of the battery 35, when coming into contact with the first and second cross brackets 50 and 60 due to expansion of the battery 35 as illustrated with a broken line in FIG. 3, to come into contact with the forward portion 50CF of the lower plate 50C or a forward portion (not shown) of the lower plate 60C, thereby preventing damage to the battery 35 caused by the first and second cross brackets 50 and 60.

The left and right end portions 58L and 58R, and 68L and 68R of the respective first and second cross brackets 50 and 60 have an L-shape cross section and therefore have reduced rigidity. This configuration reduces effects of the first and second cross brackets 50 and 60 on the deformation mode of the left and right side rails 11L and 11R in a collision.

Further, in the electric motor vehicle 100, the rearward portion of the cooling conduit line 42 and the rearward portion of the power cable 43 are supported on the center portions 59 and 69 of the first and second cross bracket 50 and 60, respectively, such that these rearward portions have substantially the same height as the respective forward portions. This configuration allows the cooling conduit line 42 to be disposed substantially horizontally, to thereby prevent accumulation of bubbles within the cooling conduit line 42 and reduce inhibition of flow of cooling water.

In the electric motor vehicle 100, to mount the first cross bracket 50 to the left and right attachment brackets 51L and 51R, the left end portion 58L is mounted to the left attachment bracket 51L, with the right end portion 58R being temporarily held by the right attachment bracket 51R, and thereafter the right end portion 58R is mounted to the right attachment bracket 51R, as described in detail below.

To mount the first cross bracket 50 to the left and right attachment brackets 51L and 51R, the plate flange 52R of the right attachment bracket 51R is first placed into the space 50S formed on the right edge of the first cross bracket 50, and is inserted between the arm portion 50D and the vertical plate 50B, as illustrated in FIG. 7. This allows the right end portion 58R of the first cross bracket 50 to be temporarily held by the right attachment bracket 51R.

Then, the left end portion 58L is mounted to the left attachment bracket 51L by inserting the bolt 71L through the bolt hole 50E of the left end portion 58L and the bolt hole 55L of the plate flange 52L with the position of the bolt hole 50E being aligned with the position of the bolt hole 55L, and then screwing the bolt 71L into the nut 73L disposed on the opposite side of the plate flange 52L.

Subsequently, the right end portion 58R is mounted to the right attachment bracket 51R by inserting the bolt 71R into the bolt hole 50F of the right end portion 58R and the bolt hole 55R of the plate flange 52R with the position of the bolt hole 50F being aligned with the position of bolt hole 55R, and screwing the bolt 71R into the nut (not shown) disposed on the opposite side of the plate flange 52R.

As described above, the left end portion 58L is first mounted to the left attachment bracket 51L with the right end portion 58R being temporarily held by the right attachment bracket 51R, and then, the right end portion 58R is mounted to the right attachment bracket 51R. This configuration enables mounting of the first cross bracket 50 to the left and right attachment bracket s51L and 51R by a single user. The second cross bracket 60 can also be mounted to the left and right attachment brackets 61L and 61R in a similar manner.

In the example described above, the electric motor vehicle 100 includes two cross brackets, the first cross bracket 50 and the second cross bracket 60, disposed within a region between the left and right side rails 11L and 11R where the deck 33 is mounted. However, the present disclosure is not limited to this example, and may be configured to support the cooling conduit line 42 and the power cable 43 with only one cross bracket, the first cross bracket 50, for example.

Alternatively, three cross brackets may be arranged at predetermined intervals between the left and right side rails 11L and 11R. This configuration prevents the cooling conduit line 42 and the power cable 43 from sagging downward and approaching the top surface 35A of the battery 35.

While in the electric motor vehicle 100 described in the above example, the arm portion 50D of the first cross bracket 50 is a plate portion extending downward from the right edge of the upper plate 50A, the arm portion 50D is not limited to this example, and may be any element extending downward from the upper plate 50A to hold the plate flange 52R between the arm portion 50D and the vertical plate 50B, such as a pin secured to the undersurface of the upper plate 50A.

While in the above example, the center portions 59 and 69 of the respective first and second cross brackets 50 and 60 have a C-shape cross section opened rearward, the cross section may have a C-shape opened frontward.

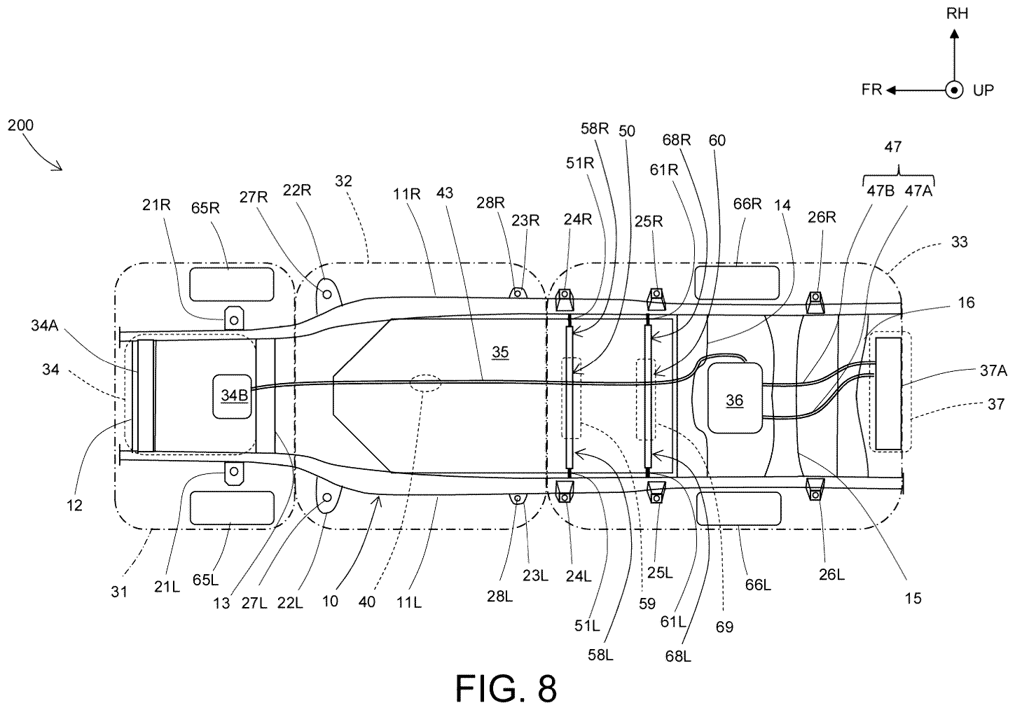

Referring now to FIG. 8, an electric motor vehicle 200 according to a further embodiment will be described. In FIG. 8, elements that are the same as those of the electric motor vehicle 100 described above by reference to FIG. 1 to FIG. 7 are denoted with the same reference numerals and will not be further described.

As illustrated in FIG. 8, the electric motor vehicle 200 includes a rear auxiliary machine unit 37 in a rearward part of the vehicle. The rear auxiliary machine unit 37 includes a rear radiator 37A that discharges heat of cooling water for use in cooling the electric motor unit 36. The rear radiator 37A and the electric motor unit 36 are connected by a cooling conduit line 47 composed of a cooling water supply line 47A and a cooling water return line 47B. The cooling conduit line 47 is supported on the fourth and fifth cross members 15 and 16.

In the electric motor vehicle 200, the power distributor 34B included in the auxiliary machine unit 34 disposed in a further forward part with respect to the battery 35 and the electric motor unit 36 disposed in a further rearward part with respect to the battery 35 are connected through the power cable 43. The power cable 43 is disposed above the center portions 59 and 69 of the respective first and second cross brackets 50 and 60.

In the electric motor vehicle 200, the power cable 43 constitutes the connecting member 40 that connects the auxiliary machine unit 34 and the electric motor unit 36.

The electric motor vehicle 200, similar to the electric motor vehicle 100, enables prevention of interference of the top surface 35A of the battery 35 that is curved upward with the power cable 43, thereby preventing thermal damage to the power cable 43.

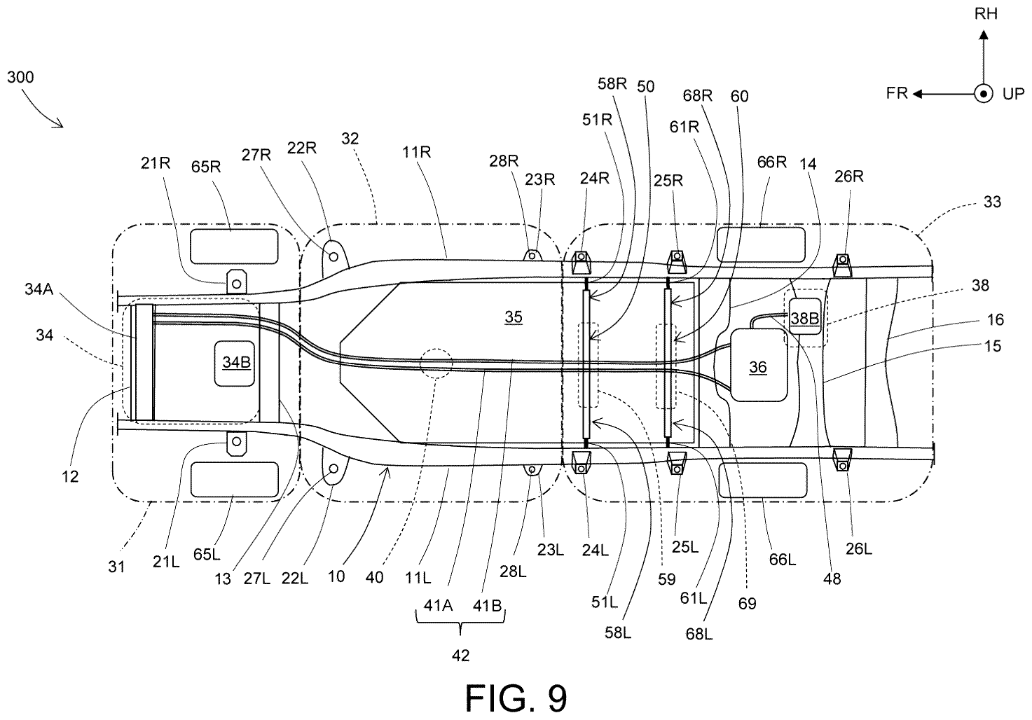

Referring now to FIG. 9, an electric motor vehicle 300 according to a still further embodiment will be described. In FIG. 9, elements that are the same as those of the electric motor vehicle 100 that are described above by reference to FIG. 1 to FIG. 7 are denoted with the same reference numerals and will not be further described.

As illustrated in FIG. 9, the electric motor vehicle 300 includes a rear auxiliary machine unit 38 including a rear power distributor 38B that supplies electric power to the electric motor unit 36. The rear power distributor 38B and the electric motor unit 36 are connected through a power cable 48.

In the electric motor vehicle 300, the radiator 34A included in the auxiliary machine unit 34 disposed in a further forward part with respect to the battery 35 and the electric motor unit 36 disposed in a further rearward part with respect to the battery 35 are connected through a cooling conduit line 42 that is disposed above the center portions 59 and 69 of the respective first and second cross brackets 50 and 60.

In the electric motor vehicle 300, the cooling conduit line 42 constitutes the connecting member 40 that connects the auxiliary machine unit 34 and the electric motor unit 36.

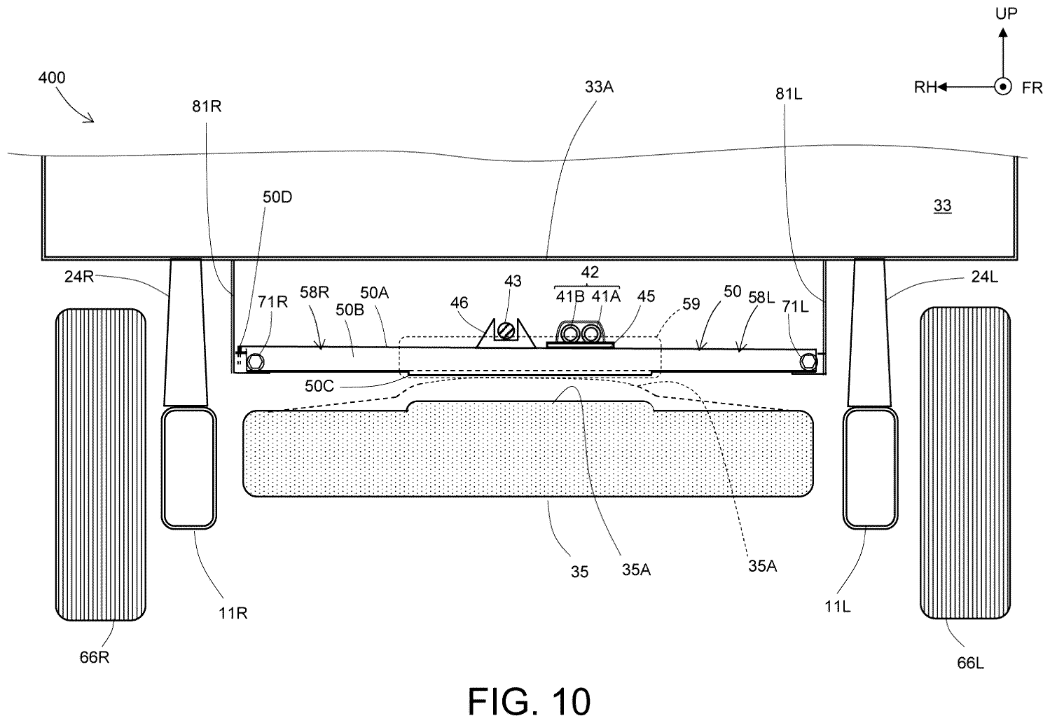

Referring further to FIG. 10, an electric motor vehicle 400 according to a still further embodiment will be described. In FIG. 10, elements that are the same as those of the electric motor vehicle 100 described above by reference to FIG. 1 to FIG. 7 are denoted with the same reference numerals and will not be further described.

As illustrated in FIG. 10, in the electric motor vehicle 400, the first cross bracket 50 is supported by hanging brackets 81L and 81R attached to the undersurface of the floor panel 33A of the deck 33. The second cross bracket 60 is similarly supported by further hanging brackets (not shown) attached to the undersurface of the floor panel 33A of the deck 33.

The operation and advantages of the electric motor vehicle 400 are the same as those of the electric motor vehicle 100 described above.

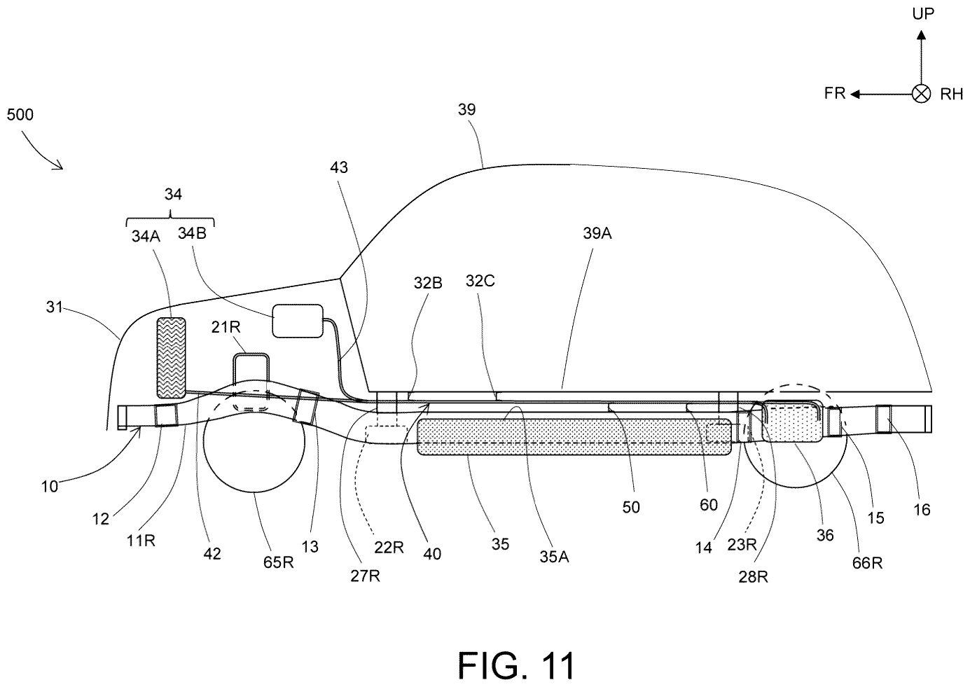

Referring now to FIG. 11, an electric motor vehicle 500 according to a still further embodiment will be described. In FIG. 11, elements that are the same as those of the electric motor vehicle 100 described above by reference to FIG. 1 to FIG. 7 are denoted with the same reference numerals and will not be further described.

As illustrated in FIG. 11, the electric motor vehicle 500 is an electric motor SUV including a cab 39 accommodating a front seat and a rear seat, in place of the cab 32 and the deck 33 of the electric motor vehicle 100. In the electric motor vehicle 500, a rear cab mount bracket 23R and a rear cab mount 28R are disposed immediately before the third cross member 14, and support the rear portion of the cab 39. Further, the hanging members 32B and 32C are supported on the floor panel 39A of the cab 39.

In the electric motor vehicle 500, similar to the electric motor vehicle 100, the radiator 34A and the electric motor unit 36 are connected through the cooling conduit line 42, and the power distributor 34B and the electric motor unit 36 are connected through the power cable 43. The cooling conduit line 42 and the power cable 43 are disposed above the center portions 59 and 69 of the respective first and second cross brackets 50 and 60. The electric motor vehicle 500, similar to the electric motor vehicle 100, enables prevention of interference of the top surface 35A of the battery 35 that curves upward, with the cooling conduit line 42 or the power cable 43, to thereby reduce thermal damage to the cooling conduit line 42 and the power cable 43.

1. An electric motor vehicle comprising:
left and right side rails extending along a length of the vehicle;
a battery disposed between the left and right side rails;
an electric motor unit disposed in a further rearward part in the vehicle with respect to the battery;
an auxiliary machine unit disposed in a further frontward part in the vehicle with respect to the battery; and
a connecting member connecting the auxiliary machine unit and the electric motor unit along the length of the vehicle, wherein
the connecting member is upwardly spaced from the battery.

2. The electric motor vehicle according to claim 1, further comprising:
at least one cross bracket extending between the left and right side rails above the battery, wherein
the connecting member is disposed above a center portion of the cross bracket in a vehicle width direction of the vehicle.

3. The electric motor vehicle according to claim 2, wherein
the at least one cross bracket includes a plurality of cross brackets, the plurality of cross brackets being arranged at predetermined intervals along the length of the vehicle.

4. The electric motor vehicle according to claim 2,
the cross bracket including, at a lower end, a planar portion extending along a top surface of the battery.

5. The electric motor vehicle according to claim 3,
each of the cross brackets including, at a lower end, a planar portion extending along the top face of the battery.

6. The electric motor vehicle according to claim 2, wherein
the cross bracket has left and right end portions each having an L-shape cross section and the center portion having a C-shape cross section opened forward or rearward of the vehicle.

7. The electric motor vehicle according to claim 3, wherein
each of the cross brackets has left and right end portions each having an L-shape cross section and the center portion having a C-shape cross section opened forward or rearward of the vehicle.

8. The electric motor vehicle according to claim 6, wherein
each of the left and right end portions of the cross bracket has an L-shape cross section composed of an upper plate and a vertical plate extending downward from the upper plate,
the electric motor vehicle further includes left and right attachment brackets configured to be attached to the left and right side rails, respectively, and extend upward, the left and right attachment brackets each having, at an upper part, a plate flange configured to be fastened to the vertical plate of each of the left and right end portions, and
the cross bracket includes an arm portion at one or both the left and right end portions, the arm portion extending downward from the upper plate to hold the plate flange of the attachment bracket between the arm portion and the vertical plate.

9. The electric motor vehicle according to claim 7, wherein
each of the left and right end portions of each cross bracket has an L-shape cross section composed of an upper plate and a vertical plate extending downward from the upper plate,
the electric motor vehicle further includes left and right attachment brackets configured to be attached to the left and right side rails, respectively, and extend upward, the left and right attachment brackets each having, at an upper part, a plate flange configured to be fastened to the vertical plate of each of the left and right end portions, and
the cross bracket includes an arm portion at one or both the left and right end portions, the arm portion extending downward from the upper plate to hold the plate flange of the attachment bracket between the arm portion and the vertical plate.

10. The electric motor vehicle according to claim 1, wherein
the auxiliary machine unit includes a radiator, and
the connecting member comprises a cooling conduit line extending along the length of the vehicle between the radiator and the electric motor unit to cause cooling water to circulate between the radiator and the electric motor unit.

11. The electric motor vehicle according to claim 1, wherein
the auxiliary machine unit includes a power distributor configured to distribute electric power from the battery, to the electric motor unit and another on-vehicle device, and
the connecting member comprises a power cable configured to transmit electric power from the power distributor to the electric motor unit.

12. The electric motor vehicle according to claim 1, wherein
the auxiliary machine unit includes a radiator and a power distributor configured to distribute electric power from the battery, to the electric motor unit and another on-vehicle device, and
the connecting member comprises a cooling conduit line extending between the radiator and the electric motor unit along the length of the vehicle to cause cooling water to circulate between the radiator and the electric motor unit, and a power cable configured to transmit electric power from the power distributor to the electric motor unit.

13. The electric motor vehicle according to claim 2, further comprising:
a cab mounted above the left and right side rails in a front part of the vehicle; and
a deck mounted in a further rearward part in the vehicle with respect to the cab above the left and right side rails, wherein
the cross bracket is disposed within a region between the left and right side rails where the deck is mounted, and
the connecting member includes a forward portion supported by a floor panel of the cab and a rearward portion disposed above the center portion of the cross bracket in the vehicle width direction to maintain a substantially identical height with the forward portion.
